(19) United States
(12) Patent Application Publication
(10) Pub. No.: US 2008/0218122 A1
(43) Pub. Date: Sep. 11, 2008

(54) BATTERY CHARGING METHOD FOR AN ELECTRIC GOLF CAR

(75) Inventors: Yukiyasu Takano, Shizuoka-ken (JP); Hiroshi Hirano, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA MOTOR ELECTRONICS KABUSHIKI KAISHA, Shizuoka-ken (JP)

(21) Appl. No.: 12/044,458

(22) Filed: Mar. 7, 2008

(30) Foreign Application Priority Data
Mar. 9, 2007 (JP) 2007-059685

(51) Int. Cl. H02J 7/00

(52) U.S. Cl. 320/109

(57) ABSTRACT

A charger and a vehicle body battery are connected together via a connector. The vehicle body includes a first CPU that determines if the vehicle body battery is being charged or not. The charger includes a second CPU that transmits a charging signal to indicate that the vehicle body is being charged. The connector connects the first CPU and the second CPU. The battery is charged by the charger. The charging signal has a periodicity with a combination of ON signals and OFF signals. The first CPU disables travel of the vehicle body only while the periodicity of the charging signal is continued.

### CROSS-REFERENCE TO RELATED APPLICATIONS

This application claims the priority benefit of Japanese Patent Application No. 2007-059685, which was filed on Mar. 9, 2007 and which is hereby incorporated by reference in its entirety.

### BACKGROUND OF THE INVENTION

1. Field of the Invention

The present invention generally relates to a battery charging method for an electric golf car. More particularly, certain features, aspects and advantages of an embodiment of the present invention relate to determining if a battery positioned in or on an electric golf car vehicle body is being charged by a charger or not.

2. Description of the Related Art

With reference initially to FIG. 4, a schematic diagram shows a conventional charger connected to a vehicle body of an electric golf car. As illustrated, a connector 33 connects a charger 31 and a vehicle body 32 of the golf car. The connector 33 comprises a charger-side plug 34 and a vehicle-side receptacle 35. The illustrated connector 33 comprises a 3-PIN connection. The connection comprises a positive terminal 37 used in charging a battery 36, a negative terminal 38 used in charging the battery 36 installed in the vehicle body 32, and a further terminal 39 used to transfer the charging signal.

The charger 31 charges the battery 36 while the charger-side plug 34 and the vehicle-side receptacle 35 are connected together. While the charger 31 charges the battery 36, a CPU 40 installed in the charger 31 transfers a charging signal via a connection cable 41. A CPU 44 installed in an MCU (motor controller unit) 43 evaluates the charging signal with a BMC (battery management controller) 42. The BMC 42 stores information about charging operations, such as a charging history information of the battery 36.

FIG. 5 is a graph showing a relationship between a signal that communicates a connection status between the charger and the vehicle body and time. As shown in FIG. 5, while the charger 31 and the vehicle body 32 are connected together (T0 through T1), a “High (ON)” signal is transferred indicating that the charger 31 and the vehicle body 32 are electrically connected. On the other hand, if they are disconnected, a “Low (OFF)” signal is transferred. That is, the ON signal is constantly transferred if the connector electrically connects the charger 31 and the vehicle body 32. Thus, it is determined that the vehicle body 32 is being charged because the charger 31 and the vehicle body 32 are connected together.

If the CPU 44 determines that the battery 36 is being charged, the CPU 44 outputs to a driving unit (not shown) of the vehicle an instruction that disables movement of the golf car body 32 during battery charging. Accordingly, because the vehicle body 32 is not able to be driven during changing, a connection part of the connector 33 is not likely to be forced apart or a cable of the plug 34 is less likely to be pulled during battery charging. Thus, damage to those parts is less likely to occur.

However, during battery charging, a short-circuit can occur to the vehicle body side connection cable 41. In such a case, the ON signal is constantly transferred to the CPU 44. That is, the CPU 44 mistakenly believes that the vehicle body 32 is being charged even though battery charging has been completed and a user has physically separated the connector 33 by pulling the plug 34 from the receptacle 35. Because the separation occurred while the connection cable 41 was short-circuited, the ON signal continues to be transferred. Thus, the CPU 44 determines that battery charging is still in progress. If a user attempts to drive the vehicle body 32 after battery charging is completed, the golf car cannot be operated because the CPU 44 does not cancel the travel disabling instruction. Similarly, if a short-circuit occurs in the connection cable 41 while a user is using the golf car, the battery charging ON signal can be transferred to the CPU 44, which results in the user not being able to operate the golf car while the golf car is on a golf course.

### SUMMARY OF THE INVENTION

A charging system for an electric vehicle is disclosed in Japanese Patent Publication No JP-A-2004-221521. The charging system provides an environment-friendly charging system, by which a mass of an electric vehicle can be made lighter. In the charging system in JP-A-2004-221521, the electric vehicle is connected to a charger using a charging station, a socket, and so forth. A relayed switch operation is made upon connection, thereby electric power is not supplied to a motor and operation of the vehicle is disabled. Therefore, because a circuit used to detect connection is not included in the system, the system not likely to have trouble with such a circuit.

Accordingly, one aspect of an embodiment of a battery charging method for an electric golf car preferably reduces the likelihood of golf car disablement due to a short-circuit in the battery charging apparatus, and therefore improves the accuracy in the determination of whether the battery is being charged or not.

Another aspect of an embodiment provides a method of charging a battery used in an electric golf car in which a charger and a vehicle body of the electric golf car are connected together with a connector. The vehicle body includes a first CPU that determines if the battery positioned in the vehicle body is being charged and the charger includes a second CPU that transmits a charging signal that indicates that the battery is being charged. The first CPU and the second CPU are connected together by a connection cable at the connector. The method comprises generating a periodicity in the charging signal such that the charging signal repeatedly alternates between an ON signal and an OFF signal, and the method comprises disabling movement of the vehicle body with the first CPU only if the periodicity of the charging signal is retained.

A further aspect of an embodiment involves an electric golf car and charger combination comprising a battery and a first CPU. A first portion of a connector is coupled to the car while a second portion of the connector is coupled to a charger. The changer comprises a second CPU and a memory location. The second CPU transmits a periodic signal to the first CPU while the first portion of the connector and the second portion of the connector are joined. The first CPU prevents operation of the golf car while the periodic signal is transmitted from the second CPU to the first CPU.

### BRIEF DESCRIPTION OF THE DRAWINGS

These and other features, aspects and advantages of the present invention will now be described with reference to the drawings of a preferred embodiment, which embodiment is intended to illustrate and not to limit the invention, and in which figures:

FIG. 1 is a schematic diagram showing a charger and a vehicle body of a golf car that are connected together during battery charging in accordance with certain features, aspects and advantages of an embodiment of the present invention.

FIG. 2 is a graph showing changes over time for a signal indicating a connection state between the charger and the vehicle body.

FIG. 3 is a flowchart of an embodiment of the battery charging method that is arranged and configured in accordance with certain features, aspects and advantages of the present invention.

FIG. 4 is a schematic diagram showing a conventional connection between the charger and the vehicle body of the golf car.

FIG. 5 is a graph showing changes over time in a conventional signal indicating a connection state between the charger and the vehicle body.

### DETAILED DESCRIPTION OF THE PREFERRED EMBODIMENT

Certain features, aspects and advantages of the present invention provide a battery charging method for an electric golf car in which a charger and a vehicle body are connected together via a connector. The vehicle preferably includes a first CPU that is used to determine if the battery in the vehicle body is being charged or not. The charger preferably includes a second CPU that is used to communicate that the battery in the vehicle body is being charged. More preferably, the second CPU communicates a charging signal. The first CPU and the second CPU can be connected together by a connection cable. In some preferred configurations, the connection cable connects at the connector. A battery is included in the vehicle body and the battery is charged by the charger. The charging signal preferably has a periodicity formed with a combination of ON signals and OFF signals, and the first CPU disables travel of the vehicle body only as long as the periodicity of the charging signal continues.

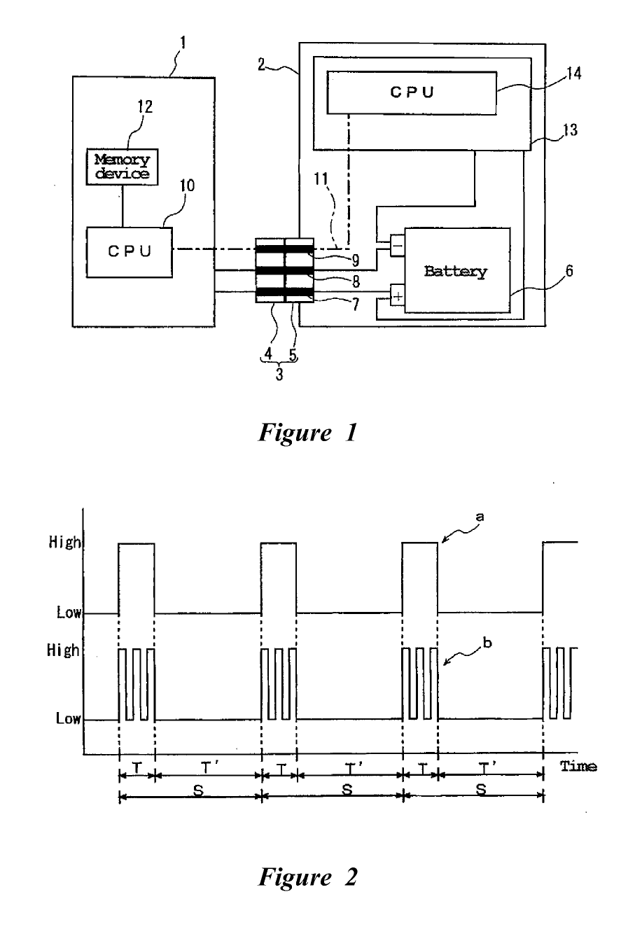

With reference now to FIG. 1, a connector 3 couples a charger 1 and a golf car vehicle body 2. The connector 3 preferably comprises a charger side plug 4 and a vehicle body side receptacle 5. In some embodiments, these may be reversed or the plug and receptacle can be formed in other configurations (e.g., identical components that couple together). The connector 3 preferably comprises a 3-PIN connection. As such, the preferred connection comprises a positive terminal 7, a negative terminal 8 and a terminal 9 that is used to transfer the charging signal. The positive terminal 7 and the negative terminal 8 preferably are used to charge the battery 6.

The charger 1 charges the battery 6 while the charger 1 and the vehicle body 2 are connected together. As used herein, the vehicle body can include a direct connection to the battery 6 unless indicated otherwise. When the charger 1 and the vehicle body 2 are connected, a CPU (e.g., a second CPU) 10 installed in the charger 1 transmits a charging signal installed through a connection cable 11 to another CPU (e.g., a first CPU) 14 that is installed in an MCU (motor controller unit) 13. The CPU 14 evaluates the charging signal.

The charger 1 charges the battery 6 based at least in part upon charging history information, which preferably is stored in a memory device 12 installed in the charger 1. The memory device 12 can be connected to the CPU 10 in the charger 1. Any suitable type of memory device can be used. Moreover, because the memory device 12 used to store the charging history information is installed in the charger 1 as described above, the vehicle does not have to include a BMC for storing such information. Thus, the vehicle body can be made lighter.

When the plug 4 and the receptacle 5 of the connector 3 connect, signals such as those indicated in FIG. 2 can be transferred. As illustrated, the charging signal preferably is formed by a switch mechanism, for example, that outputs ON and OFF signals at a constant electric potential. Preferably, a “High (ON)” signal for a time T and a “Low (OFF)” signal for a time T′ can be transferred in a periodicity for a time S as indicated in the line (a) of FIG. 2. The ON signal in this case indicates that the connection cable 11 is electrically connected, and the OFF signal indicates that the connection cable 11 is electrically disconnected. Therefore, voltage applied in the OFF signal preferably is 0 V.

Only if a CPU 14 installed in the vehicle body 2 recognizes a charging signal having such a periodicity will the CPU 14 determine that the battery 6 mounted in the vehicle body 2 is being charged. When the CPU 14 determines that the battery 6 is being charged, the CPU 14 outputs an instruction that disables operation of the vehicle body 2. In some embodiments, the operation disabling instruction is not canceled unless the CPU 10 transfers no charging signal and the CPU 14 determines that the vehicle body 2 is not being charged. Thus, the vehicle body 2 is less likely to be accidentally operated during battery charging.

If a communication cable for transferring digital data is used as the connection cable 11, and if a periodicity similar to the periodicity described above is given to a data transferring period as indicated at line (b) in FIG. 2, the charging information from the memory device 12 can be sent in addition to the charging signal. Accordingly, another cable is not required to transfer the charging signal and the number of parts can be reduced such that the system can be simplified.

In some preferred embodiments, the charging signal has a periodicity as described above. Therefore, if a short-circuit occurs in the connection cable 11 on the vehicle body 2 side, the ON signal will be constantly transferred to the CPU 14. In other words, the periodicity of the charging signal is lost and the CPU 14 therefore cancels the operation disabling instruction that is being transmitted. As a result, the vehicle is less likely to be disabled by a faulty signal indicating that the battery is being charged while the battery is not actually being charged. If a short-circuit occurs to the connection cable 11 while charging the vehicle body 2, the CPU 14 determines that battery charging is not in progress although battery charging still is in progress. The CPU 14 only provides the travel disabling instruction to the vehicle body 2 during the battery charging. Charging history and discharging history of the battery 6 are stored in the memory device 12 in the charger 1 and battery charging is made based on the history. Therefore, there is no influence on charging the battery 6.

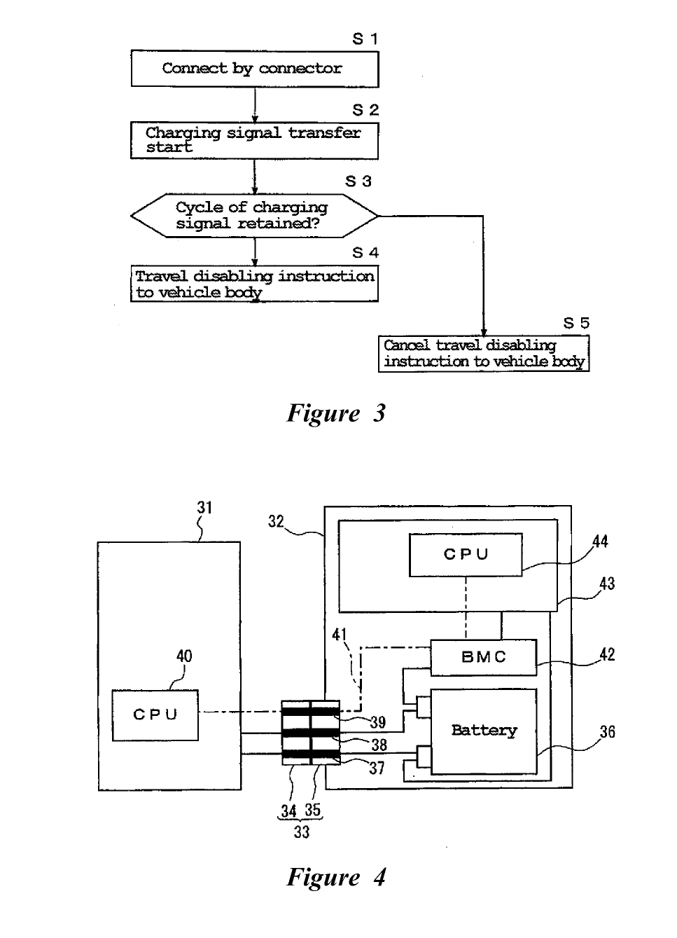

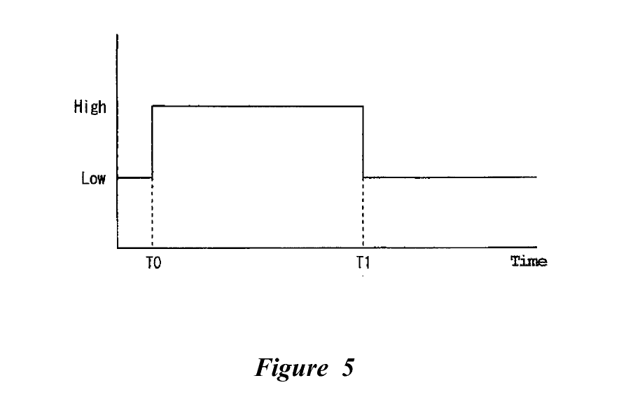

FIG. 3 is a flowchart of the battery charging method for an electric golf car according to the present invention.

### Step S1:

The charger and the golf car are connected together via the connector. Thereby, charging the battery installed in the vehicle body starts.

### Step S2:

The second CPU installed in the charger transfers a charging signal to the first CPU installed in the vehicle body. The charging signal has a periodicity with a repetition of ON signals and OFF signals indicating the presence of an electric connection between the first CPU and the second CPU.

### Step S3:

The first CPU installed in the vehicle body determines if the periodicity of the charging signal is continuing or not.

### Step S4:

If the periodicity of the charging signal is continuing in step S3, the first CPU installed in the vehicle body determines that the battery is being charged and outputs the travel disabling instruction to the vehicle body.

### Step S5:

If the first CPU does not recognize that the periodicity of the charging signal is continuing in step S3, the first CPU installed in the vehicle body determines that the battery is not being charged and cancels the travel disabling instruction to the vehicle body.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A method of charging a battery used in an electric golf car in which a charger and a vehicle body of the electric golf car are connected together with a connector, the vehicle body including a first CPU that determines if the battery positioned in the vehicle body is being charged and the charger including a second CPU that transmits a charging signal that indicates that the battery is being charged, the first CPU and the second CPU being connected together by a connection cable at the connector, the method comprising:
generating a periodicity in the charging signal such that the charging signal repeatedly alternates between an ON signal and an OFF signal, and
disabling movement of the vehicle body with the first CPU only if the periodicity of the charging signal is retained.

2. The method of claim 1, wherein the connection cable is a communication cable for transferring digital data.

3. The method of claim 2, wherein the charger comprises a memory device that stores charging information of the battery, which information is used during battery charging.

4. An electric golf car and charger combination comprising a battery and a first CPU, a first portion of a connector coupled to the car, a second portion of the connector coupled to a charger, the changer comprising a second CPU and a memory location, the second CPU transmitting a periodic signal to the first CPU while the first portion of the connector and the second portion of the connector are joined, the first CPU preventing operation of the golf car while the periodic signal is transmitted from the second CPU to the first CPU.

5. The combination of claim 4, wherein the first CPU allows operation of the golf car once the periodic signal is terminated.

6. The combination of claim 4, wherein data regarding battery charging is periodically transmitted to the first CPU.

7. The combination of claim 4, wherein data regarding battery charging is stored in the memory of the charger.
